(19) United States
(12) Patent Application Publication
(10) Pub. No.: US 2004/0080186 A1
(43) Pub. Date: Apr. 29, 2004

(54) Service center for a recreational vehicle

(76) Inventors: Jean-Phillipe Crepeau, Bromont (CA); Pierre Rondeau, St-Denis-de-Brompton (CA)

Correspondence Address: PILLSBURY WINTHROP, LLP, P.O. BOX 10500, MCLEAN, VA, 22102, US

(21) Appl. No.: 10/657,080

(22) Filed: Sep. 9, 2003

Related U.S. Application Data
(60) Provisional application No. 60/408,918, filed on Sep. 9, 2002.

(51) Int. Cl. B60N 3/00

(52) U.S. Cl. 296/203.01; 296/1.01

(57) ABSTRACT

A vehicle is disclosed that includes a frame, a seat, a steering device disposed on the frame to control a steerable member, and an engine. At least one component is operatively connected to one of either the engine or a steerable member. A fairing is incorporated into the frame. The fairing has a first surface forming at least a portion of an outer surface of the vehicle. The fairing also has a second surface, at least a portion of which is offset a predetermined distance from the first surface. The second surface is disposed adjacent the at least one component. The second surface defines at least one hole therethrough permitting access to the at least one component.

### CROSS-REFERENCE TO RELATED APPLICATIONS

This application claims the benefit of priority to U.S. Provisional Application No. 60/408,918, titled “SERVICE CENTER FOR A RECREATIONAL VEHICLE,” filed Sep. 9, 2002, which is incorporated be reference herein in its entirety.

### BACKGROUND OF THE INVENTION

1. Field of the Invention

The present invention relates to the construction of a recreational vehicle. More specifically, the present invention relates to the construction of a service center for a recreational vehicle.

2. Description of Related Art

All terrain vehicles (“ATVs”) typically are constructed with a frame and three or more wheels suspended from the frame. Generally, an internal combustion engine powers the wheels. A handle bar type steering device is connected to the front wheel or wheels to steer the vehicle.

Many ATVs are designed to haul items. Accordingly, manufacturers typically incorporate storage racks at the front and rear of the vehicle. In particular, the storage racks are usually affixed to the frame above the fairings that constitute the body of the vehicle.

In the typical ATV design, the engine is located at or near the front of the vehicle, usually beneath the front rack. Since access to certain components of the engine may be required for general maintenance, manufacturers have commercialized certain designs to facilitate access to those components. In particular, as is typical for most vehicles powered by an internal combustion engine, manufacturers have designed ATVs where access to the radiator cap is facilitated without the need for removing the front storage rack and the front fairings to gain access thereto.

One example of such a construction is illustrated in FIG. 1, which depicts a portion of a vehicle known as the Sportsman 400. The Sportsman is believed to have been introduced commercially by Polaris Industries of Medina, Minn. in the 2001 model year.

The Sportsman 400 is generally referred to by reference numeral 10 in FIG. 1. At its front end 12, the ATV 10 has a fairing 14 onto which a front storage rack 16 is affixed. The steering handlebars 18 are positioned rearwardly of the front storage rack 16. A headlamp 20 is disposed on the forward portion of a fairing 22, which is attached to the handlebars 18. The frame of the ATV 10 is covered generally with body elements 24. A seat 26 is positioned behind the handlebars 18.

A hatch 28 is positioned in front of the steering handlebars 18 behind the front storage rack 16. As illustrated in FIG. 2, the hatch forwardly to expose a radiator 30. The hatch 28 permits access to the radiator cap 32 so that coolant may be added to the radiator 30 and the cooling system.

FIG. 3 illustrates a similar construction for an ATV 34 known as the KVF, which was manufactured by Kawasaki in its 2001 model year line-up. Like the ATV 10, the ATV 34 has a front end 36 onto which a front storage rack 38 is mounted via brackets 40. The ATV 34 also has fairings 42 that cover the frame of the vehicle. A steering handlebar 44 is disposed rearwardly of the front storage rack 38 in front of the seat 46. Like the ATV 10, the ATV 34 includes a hatch 48 on a portion of the fairing 42 between the front storage rack 38 and the steering handlebars 44.

Like the hatch 28 on the ATV 10, the hatch 48 on the ATV 34 is removable as shown in FIG. 4. When removed, the hatch 48 exposes a portion of the radiator cap 50 and a portion of the radiator 52. Access to the radiator cap 50 permits the operator to fill the cooling system on the ATV 34 without having to remove the storage rack 38 or the fairings 42.

FIG. 5 illustrates a slightly different approach taken by Bombardier Inc., a Canadian Corporation in Valcourt, Québec, on its Traxter ATV, which was manufactured in 1999. As FIG. 5 illustrates, the ATV 54 includes a radiator cap cover 56 exposed beneath the front storage rack 58 the front fairing 60. So that the radiator cap cover 56 may be removed easily to expose the radiator cap beneath, finger depressions 62 are provided in the fairing 60.

Each of the three designs discussed above adequately facilitates access to the radiators of the associated ATVs 10, 34, 54. The designs, however, do not facilitate access to other components connected to the internal combustion engines that power the vehicles. For an operator to access any such components, the operator typically must remove the front storage racks 16, 38, 58 and the fairings 14, 42, 60 before maintenance work may be performed. This is an inconvenience for which a solution has not been forthcoming.

Similar inconveniences exist for other types of recreational vehicles, including personal watercraft (“PWCs”), snowmobiles, and boats. Those inconveniences also remain unaddressed by the prior art.

### SUMMARY OF THE INVENTION

It is, therefore, one aspect of the present invention to provide a construction for a vehicle that facilitates access to a number of components associated with the engine.

It is another aspect of the present invention to provide a construction for a vehicle that permits access to at least two components associated with the engine so that routine maintenance may be facilitated.

It is, therefore, one aspect of the present invention to provide a vehicle with a frame, a straddle-type seat supported by the frame, and a steerable member supported by the frame providing directional control for the frame. A steering device is disposed on the frame and is constructed to control the steerable member. An engine is disposed on the frame to propel the frame. A plurality of components are operatively connected to the engine. A fairing is incorporated into the frame. The fairing has a first surface forming at least a portion of an outer surface of the vehicle. The fairing also has a second surface, at least a portion of which is offset a predetermined distance from the first surface, the second surface being disposed adjacent at least one of the plurality of components. The second surface defines at least one hole therethrough permitting access to the at least one component.

Another aspect of the present invention is to provide a vehicle with a service center that facilitates access at least to one or more of the following components: at least a portion of a brake fluid system, a brake fluid reservoir, a brake fluid fill spout, at least a portion of a coolant system, a coolant reservoir, a coolant reservoir fill spout, at least a part of a radiator, a radiator overflow, a radiator fill spout, an electronic control unit, at least part of an engine oil system, an engine oil fill spout, a battery, and a fuse box.

Still another aspect of the present invention is to provide a vehicle where the fairing, including a service center, is attached to the frame by at least one fastener.

Other aspects of the present invention will be made apparent in the discussion of the present invention that follows.

### BRIEF DESCRIPTION OF THE DRAWINGS

Various aspects and embodiments of the present invention are shown throughout the drawings, in which:

FIG. 1 is a partial perspective view of an ATV manufactured by Polaris Industries for the 2001 model year under the name “Sportsman 400”;

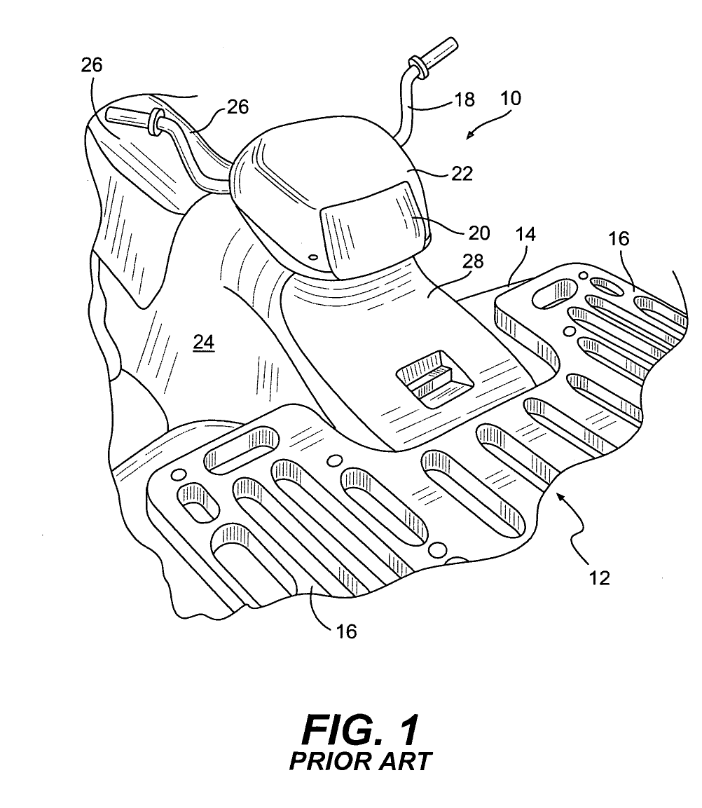

FIG. 2 is an enlarged perspective detail of a portion of the ATV illustrated in FIG. 1, showing the radiator behind an openable hatch;

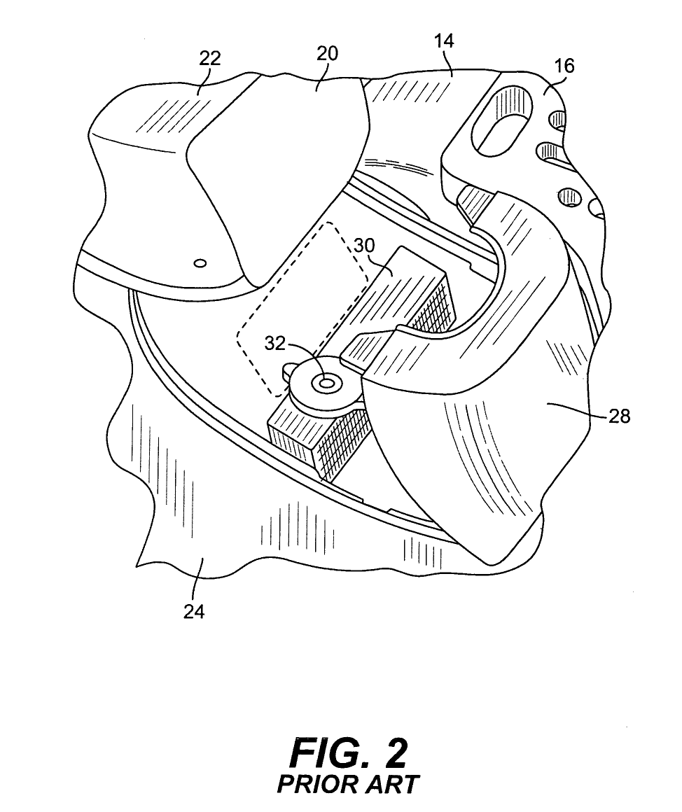

FIG. 3 is a partial perspective illustration of an ATV manufactured by Kawasaki for the 2001 model year, called the “KVF”;

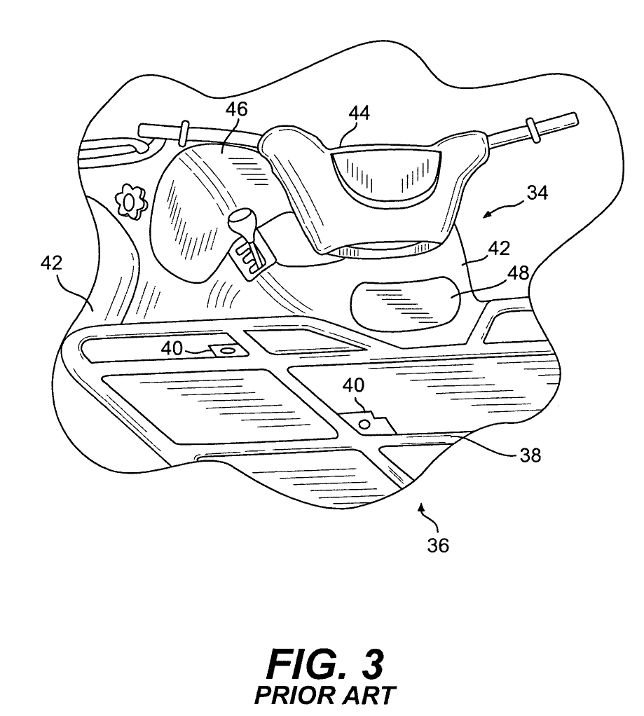

FIG. 4 is an enlarged perspective detail of a portion of the ATV illustrated in FIG. 3, showing the radiator behind a removable hatch;

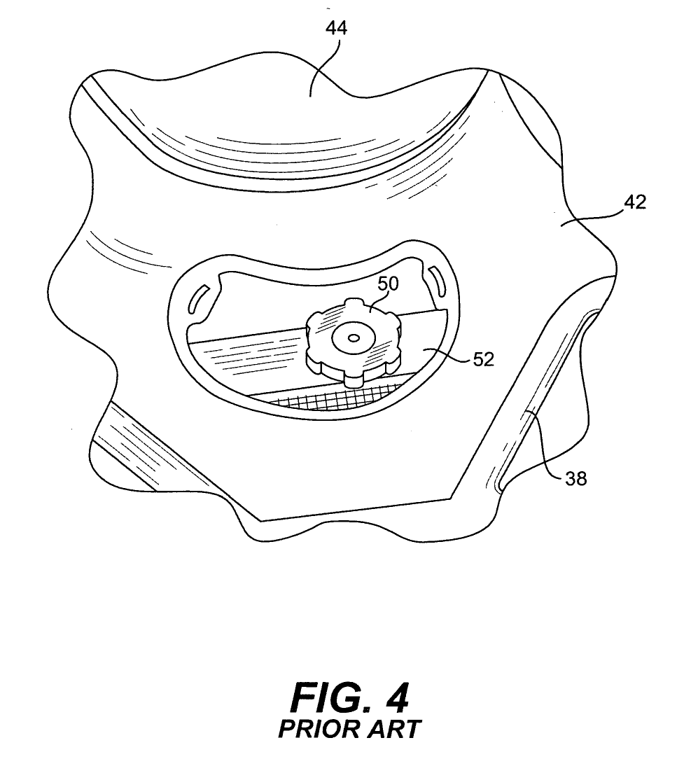

FIG. 5 is a close-up detail of a portion of an ATV manufactured by Bombardier Inc. for the 1999 model year under the name “Traxter™”;

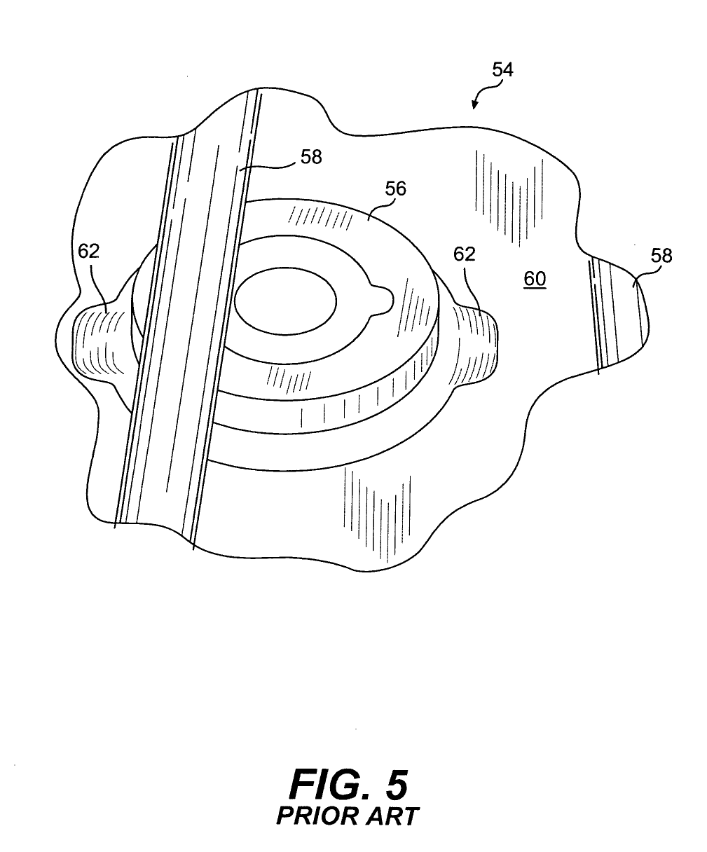

FIG. 6 is a side view of a prior art ATV, which is exemplary of the type of vehicle, among others, that is the focus of the present invention;

FIG. 7 is a perspective, top view of one possible embodiment of the present invention, showing the positioning of service centers at the front and rear of an ATV;

FIG. 8 is an enlarged, perspective, top view of the front service center illustrated in FIG. 7;

FIG. 9 is an enlarged top view of the front service center illustrated in FIG. 8, showing the fuse box cover removed, exposing electrical components therebeneath;

FIG. 10 is an enlarged top view of the front service center illustrated in FIG. 8;

FIG. 11 is a perspective top view of a cover for the front or the rear service center;

FIG. 12 is a bottom view of the cover for the front or rear service center illustrated in FIG. 11;

FIG. 13 is an enlarged top view of the rear service center illustrated in FIG. 7;

FIG. 14 is a top view of the rear service center illustrated in FIG. 13, shown with the cover to the rear service center removed;

FIG. 15 is a perspective partial cross-sectional view illustrating one embodiment of the attachment between the front rack and the frame of the ATV; and

FIG. 16 is an enlarged cross-sectional detail of the attachment illustrated in FIG. 15.

### DETAILED DESCRIPTION OF THE INVENTION

Before delving into the details of the service center of the present invention, it is first noted that the “front,” “rear,” “left,” and “right” sides are defined according to the forward travel direction of the vehicle. With this convention, the left side of the vehicle is also the left side of a rider seated thereon, when facing forward.

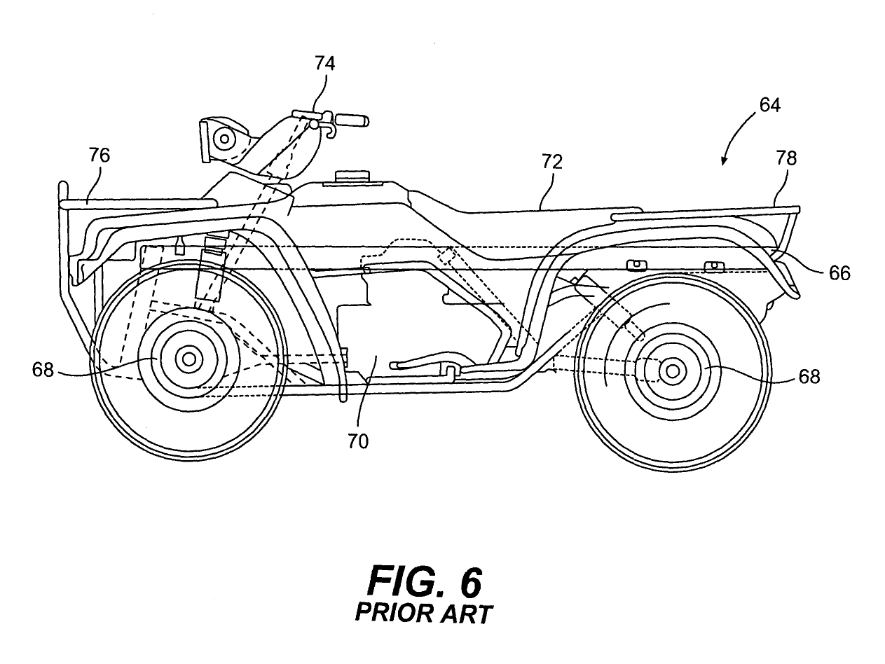

FIG. 6 provides a side view of one typical ATV 64 known in the prior art. This figure is presented to provide a fundamental overview of the construction of ATVs so that the advantages of the prior art may be more clearly understood.

ATV 64 includes a frame 66 from which four wheels 68 are suspended. An internal combustion engine 70 is mounted within the frame 66 and is operatively connected to one or more of the wheels 68 to propel the ATV 64. Typically, the engine 70 is operatively connected to one or more of the rear wheels 68, but front wheel drive ATVs are also known. The ATV 64 include a seat 72, which an operator straddles to ride the vehicle. Accordingly, the seat 72 is often referred to as a “straddle seat” or as a “straddle-type seat.” Steering handlebars 74 are positioned in front of the seat 72 so that the operator may steer the vehicle 64. The steering handlebars 74 are connected to the two wheels 68 at the front of the ATV 64. The ATV 64 also includes front and rear storage racks 76, 78, both of which are connected to the frame 66. The front and rear storage racks 76, 78 are provided so that large objects may be hauled by the ATV 64.

As discussed above, there are many varieties of ATVs that have been made commercially available. The present invention, described more fully below, is an ATV 80 that offers several advantages over ATVs known in the prior art. Portions of the ATV 80 that are not relevant to the discussion of the invention have been removed for clarity. For example, the seat, handlebars, and tires are not illustrated in the figures.

Before continuing, it should be noted that the present invention is being discussed in connection with the design of an ATV. However, it is contemplated that the invention may be applied with equal success to other types of recreational vehicles, including snowmobiles, personal watercraft, boats, and three-wheeled vehicles. Accordingly, while the discussion that follows concentrates on aspects of an ATV, those skilled in the art would appreciate that the service center may be adapted to other types of recreational vehicles as is contemplated by the present invention.

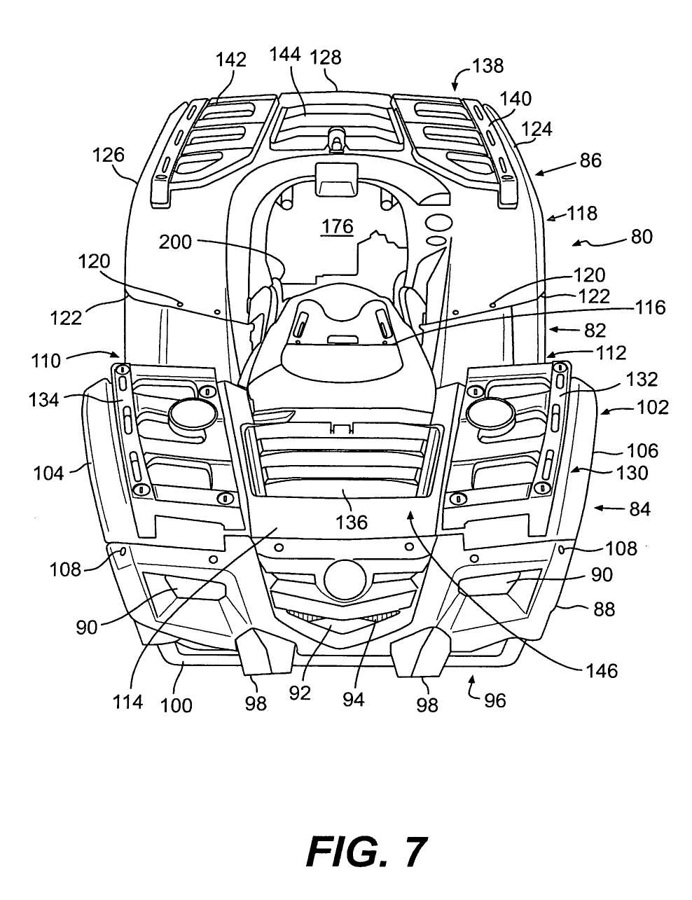

As shown in FIG. 7, one embodiment of the present invention concerns the construction of the body of an ATV 80. A portion of the body 82 of the ATV 80 of the present invention is illustrated in FIG. 7. The body 82 is divisible into two distinct portions, a front portion 84 and the rear portion 86.

The front portion 84 includes a front fender assembly 88, which has two openings 90 therethrough for the vehicle's headlamps. The front fender assembly 88 also has at least one opening 92 through which air may be directed to the vehicle's radiator 94. The front fender assembly 88 preferably is constructed from a thermoplastic material that demonstrates at least some degree of flexibility. So constructed, the front fender assembly 88 is able to withstand impacts from twigs, dirt, rocks, or other objects that the ATV 80 may encounter when off-road.

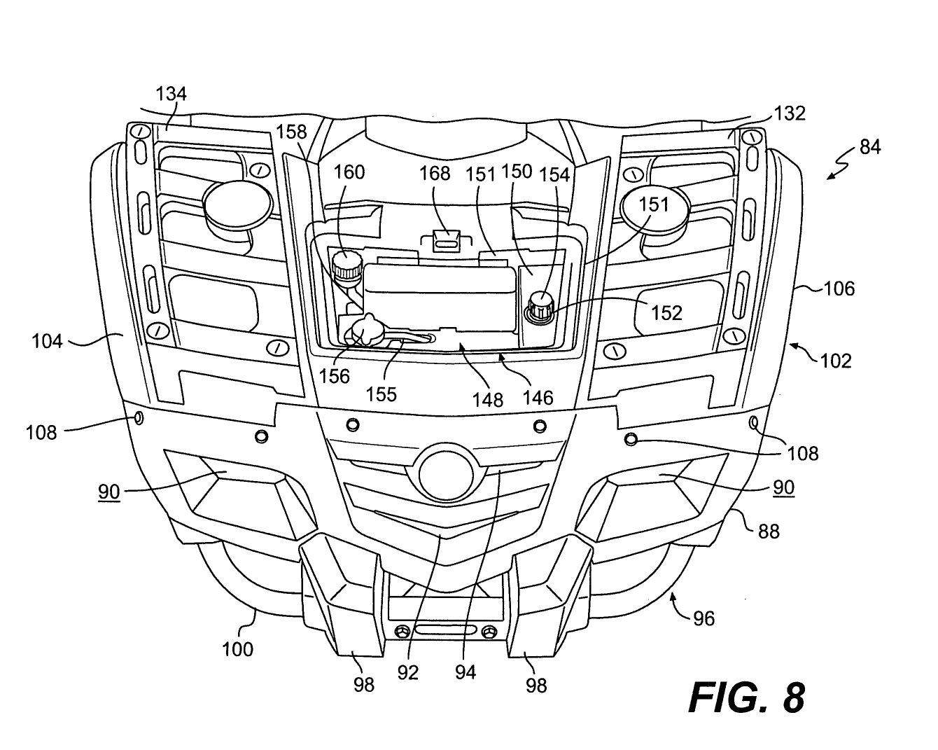

A bumper 96 extends forwardly of the front fender assembly 88. As illustrated in FIGS. 7 and 8, the bumper 96 comprises at least two elements. The first elements are the flexible bumper stops 98 that extend forwardly from the front fender assembly 88. The second is the impact bar 100. Like the front fender assembly 88, the flexible bumper stops 98 preferably are made of a flexible substance such as a thermoplastic material. The impact bar 100, on the other hand, preferably is constructed of metal such as steel, iron, aluminum, or other suitable rigid substance. The flexible bumper stops 98 are designed to absorb the energy of a head-on impact with an object during operation. The impact bar 100, while also designed for the same purpose, is also designed to direct twigs, branches, and the like away from the front of the ATV 64 during operation.

A front fairing assembly 102 extends from one side of the ATV 80 to the other. The left fender 106 that covers the left front tire and the right fender 104 that covers the right front tire are integrally formed as part of the front fairing assembly 102. As would be appreciated by those skilled in the art, however, the right fender 104 and the left fender 106 may be molded as separate components that are attached to the front fairing assembly 102 during construction of the ATV 80.

The front fairing assembly 102 preferably is constructed from a light weight material that is flexible. A thermoplastic material is preferred because it is easily molded into the appropriate shape and is sufficiently flexible to resist denting and damage, should the ATV 80 be subjected to rough off-road use. As would be appreciated by those skilled in the art, however, any other suitable material (e.g., sheet metal, fiberglass, etc.) may be substituted therefor.

The front fender assembly 88 preferably is connected to the front fairing assembly 102 via a plurality of fasteners 108, which may be of a nut and bolt construction, with the bolt being on the interior of the body 82 of the ATV 80. Naturally, as would be appreciated by those skilled in the art, the fasteners 108 may be of any other suitable type that would permit the removable connection of the front fender assembly 88 to the front fairing assembly 102. Alternatively, the front fender assembly 88 could be affixed to the front fairing assembly 102 via an adhesive. In one further alternative example, the front fender assembly 88 could be molded as an integral component of the front fairing assembly 102.

The front fairing assembly 102 extends from the front fender assembly 88 toward the rear of the ATV 80. In particular, as illustrated in FIG. 7, the front fairing assembly 102 extends to a position behind the right and left foot wells 110, 112. The front fairing assembly 102 includes a central hood area 114 with a steering column fairing portion 116 therebehind. The steering column fairing portion 116 extends upwardly to cover the mechanical components associated with the steering handlebar for the ATV 80.

The front fairing assembly 102 connects to a rear fairing assembly 118 via a plurality of fasteners 120. The front fairing assembly 102 and the rear fairing assembly 118 meet one another at a seam 122 just behind the right and left foot wells 110, 112. As with the front fairing assembly 102, the rear fairing assembly 118 preferably is molded from a flexible, thermoplastic material to resist denting and damage. As would be appreciated by those skilled in the art, any other suitable material may be substituted therefor, without deviating from the scope of the present invention.

Also, as would be appreciated by those skilled in the art, the front fairing assembly 102 and the rear fairing assembly 118 need not be the primary two components making up the body 82 of the ATV 80. Instead, the front fairing assembly 102 and the rear fairing assembly 118 each may comprise a number of separate fairing portions that are assembled together. In addition, while it is contemplated that the front fairing assembly 102 and the rear fairing assembly 118 connect with one another behind the right and left foot wells 110, 112, the front and rear fairing assemblies 102, 118 may connect to one another at any other suitable location between the front portion 84 and the rear portion 86 of the ATV 80.

Like the front fairing assembly 102, the rear fairing assembly 118 includes a left fender 124 that extends laterally outwardly to cover the left rear wheel. The rear fairing assembly 118 also includes a right fender 126 that extends laterally outward to cover the right rear wheel. A central rear area 128 extends between the left rear fender 124 and the right rear fender 126. The central rear area 128 also is a part of the rear fairing assembly 118.

As illustrated in FIG. 7, the rear fairing assembly 118 preferably is molded as a single component that extends from the left rear fender 124 to the right rear fender 126. However, the left rear fender 124, the central rear area 128, and the right rear fender 126 may be manufactured as separate components that are assembled together without departing from the scope of the present invention.

In addition, the rear fairing assembly preferably 118 is manufactured as a single component of the ATV 80. In particular, it is preferred that the rear fairing assembly 118 be molded as an integral unit from plastic or a thermoplastic material. However, as would be appreciated by those skilled in the art, the rear fairing assembly 118 may be manufactured from any suitable material including steel, aluminum, etc., just as with the front fairing assembly 102.

Also as illustrated in FIG. 7, the front fairing assembly 102 has a front storage rack 130 disposed thereon. The front storage rack 130 comprises three separate sections in the embodiment illustrated. A left front rack portion 132 is positioned above the left front fender 106. A right front rack portion 134 is similarly positioned above the right front fender 104. A central front rack portion 136 is positioned in the central hood area 114. In the embodiment illustrated, the central front rack 136 also doubles as a hood or cover over the service center, which will be described in greater detail below.

At the rear portion 86 of the ATV 80, the rear fairing assembly 118 has rear storage rack 138 disposed thereon as well. The rear storage rack 138 comprises three separate sections, as does the front storage rack 130. A left rear rack portion 140 is positioned above the left rear fender 124. A right rear rack portion 142 is disposed above the right rear fender 126. A central rear rack portion 144 is positioned above the central rear area 128 of the rear fairing assembly 118. In the illustrated embodiment, the central rear rack portion 144 doubles as a trunk or cover over a service center at the rear end 86 of the ATV 80. Alternatively, the central rear rack portion 144 doubles as a cover over a storage compartment formed as a part of the rear fairing assembly 118.

Each of the rack portions 132, 134, 140, 144 preferably comprise a resilient material such as plastic, thermoplastic, or a suitable equivalent thereof. The rack portions 132, 134, 140, 144 preferably are attached to the front and rear fairing assemblies 102, 118 through a suitable fastener, the details of which are provided below. Plastic is the preferred material for the construction of the rack portions 132, 134, 140, 144, because plastic is flexible, resists denting and deformation, resists degradation when exposed to weather conditions for extended periods of time, and is easily cleaned, among other reasons. As would be appreciated by those skilled in the art, however, materials other than plastic may be used. For example, the rack portions 132, 134, 140, 144 may be made of a suitable metal, such as steel or aluminum, or a composite, including carbon fibers.

Similarly, the rack portions 136, 144 preferably comprise a resilient material such as plastic, thermoplastic, or a suitable equivalent thereof. Plastic is preferred for the reasons set forth above. Metal or a composite material may be used instead of plastic, as would be appreciated by those skilled in the art. However, a heavy material for the rack portions 136, 144, is not preferred because these portions serve as covers over compartments therebeneath. As a result, it is preferred to keep these rack portions 136, 144 as light in weight as possible to facilitate access to the compartments that they cover. Both rack portions 136, 144, which will be described in greater detail below, preferably are supported by the front and rear fairing assemblies 102, 118 and are connected thereto.

The front and rear portions 84, 86 of the body 82 define a central opening 176 therethrough. The central opening 176 is the location where the straddle-type seat is disposed on the ATV 80. The central opening 176 also is the location through which other elements of the ATV 80 pass.

FIG. 8 is an enlarged view of the front portion 84 of the ATV 80 illustrated in FIG. 7. In this illustration, the central front rack portion 136 has been removed to reveal details of the front service center 146 thereunder. The front service center 146 is the location on the ATV 80 where a number of items may be accessed easily. In particular, it is contemplated that the accessible items include, but are not limited to, at least a portion of a brake fluid system, a brake fluid reservoir, a brake fluid fill spout, at least a portion of a coolant system, a coolant reservoir, a coolant reservoir fill spout, at least a part of a radiator, a radiator overflow, a radiator fill spout, an electronic control unit, at least part of an engine oil system, an engine oil fill spout, a battery, and a fuse box.

As shown in FIG. 8, the front service center 146 is essentially a depression 148 in the front fairing assembly 102 at a central location between the left and right front rack portions 132, 134. While the front service center 146 is centrally located in the illustrated embodiment, it is noted that the front service center 146 could be positioned at any location at the front end 84 of the ATV 80 without deviating from the scope of the present invention. In particular, the front service center 146 could be offset toward the left or right fenders 104, 106 without deviating from the scope of the present invention.

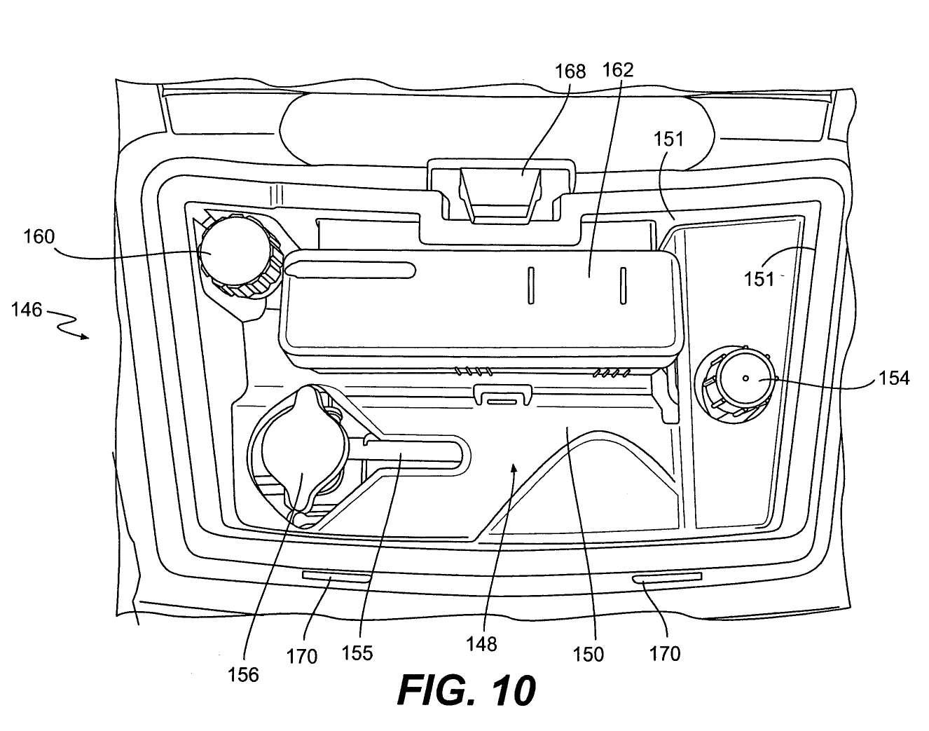

In the embodiment illustrated in FIG. 8, the depression 148 is essentially trapezoidally-shaped. The depression 148 includes a number of holes therethrough so that selected components may protrude through the bottom 150 of the depression 148. As shown, a filler neck 152 for the coolant reservoir protrudes through a left-hand side of the bottom 150 of the depression 148. The coolant filler neck 152 is provided with a coolant filler cap 154 to prevent coolant from spilling out of the reservoir when the ATV 80 is in motion. The radiator cap 156 also protrudes through the bottom 150 of the depression 148. When removed, the radiator cap 156 provides access to the interior of the radiator disposed beneath the bottom 150 of the depression 148. A coolant hose 155 connects the radiator to the coolant reservoir. A brake fluid reservoir 158 also extends through the bottom 150 of the depression 148. The brake fluid reservoir 158 includes a brake fluid cap 160, which seals off the reservoir 158. As shown in FIG. 10, the depression 148 also includes an electrical component cover 162. The electrical component cover 162 preferably covers the fuse box and ECU for the ATV 80.

So that the service center 146 offers great convenience to the vehicle operator, as illustrated in FIG. 8, it is preferred that multiple components be “clustered” together so that they all protrude through the bottom 150 of the depression. “Clustering” refers to an aspect of the invention where components at the front and rear of the vehicle are grouped together. In other words, so that access is provided to a number of components simultaneously, it is preferred that the components to which access is desired be concentrated at the location of the service center 146, whether that service center be located at the front portion 84 or the rear portion 86 of the vehicle, such as the ATV 80.

As may be appreciated, the selected components that protrude through the bottom 150 of the depression 148 are: (1) operatively connected to the engine, or (2) operatively connected to at least one of the steered members of the vehicle. The present invention is intended to encompass either connection and others that would be appreciated by those skilled in the art.

For example, the coolant system, which includes the coolant reservoir, the coolant fill spout, the radiator, the radiator overflow, and the radiator fill spout is operatively connected to the engine. Similarly, the electronic control unit, the engine oil system, including the engine oil fill spout, the battery, and the fuse box are also operatively connected to the engine. Each of these components concern a fluid system or an electrical system that are operatively connected to the engine to assist with the operation of the engine.

The brake fluid system, which includes the brake fluid reservoir and the brake fluid fill spout, on the other hand, may or may not be operatively connected to the engine. In the case of power-assisted braking systems, it is known in the automobile art to connect the brake system to the engine or to the battery so that power from the engine may be used to enhance the braking power of the system. Other types of braking systems are not connected to the engine or to the battery and operate independently therefrom.

In the case of power-assisted braking systems, those skilled in the art recognize that a number of different systems may be employed. In one example, the vacuum pressure of the engine may be operatively coupled to the brake system to boost the power applied by the brakes when actuated. Hydraulic booster systems are also known. Hydraulic booster systems rely on the engine's power steering pump (or other fluid pump operatively connected to the engine) to increase hydraulic pressure applied by the master cylinder in the braking system. Electro-hydraulic systems are also known in the automotive industry. In these systems, an electrical pump is connected to the engine's battery to increase the pressure in the master cylinder so that braking power may be increased without additional force exerted by the vehicle's operator.

Braking systems that are connected to the vehicle's steered member (such as a tire) and not to the engine are also known. Here, the braking systems are not operatively connected to the engine or the engine's battery. These hydraulic braking systems do not have a power-assist functionality. In these systems, the operator of the brake system supplies all of the force necessary to stop the vehicle. When the operator applies pressure to the brake actuator, that pressure is applied through the master cylinder to the brake calipers that act on the brake disc(s) connected to one or more of the vehicle's steered members (such as the vehicle's wheel(s)). Cable-operated braking systems are also known, such as those for bicycles. When the operator applies pressure to the brake actuator, the operator typically pulls on a cable which transmits the braking force to one or more of the braking calipers, thereby forcing them to engage the associated braking surface(s).

Therefore, there are at least two possible operative connections for a braking system. In the case of power-assisted braking systems, the components of the braking system are operatively connected to the engine or to engine's battery so that they receive operative power therefrom. In the case of braking systems that are not power-assisted, the components are not operatively connected to the engine or the engine's battery. Instead, these systems are connected to the wheels (or other steered members) of the vehicle, such as the wheels of the ATV 80. For purposes of this application, it is noted that, if the braking system is connected to the battery, this connection is considered to be an operative connection to the engine, since the battery is connected to the engine.

The braking systems for snowmobiles (or other tracked vehicles) operate slightly differently from those of wheeled vehicles. In a snowmobile, the engine is operatively connected to an endless track beneath the vehicle to provide propulsive force. The brake disc for a snowmobile typically is connected to an intermediate shaft disposed between the engine and the endless track. As a result, when the operator actuates the braking system, calipers act on the disc to stop the rotation of the intermediate shaft. This stops movement of the endless track, which stops the vehicle. In this case, since the braking system operates on a shaft connected to the engine, the braking system is considered to be operatively connected to the engine.

As may be appreciated from FIG. 8, the bottom 150 of the depression 148 essentially surrounds each of the components that extend therethrough. As a result, when the operator chooses to fill one of the reservoirs, if excess fluid is spilled, the excess fluid will not fall onto the engine or other components. Instead, the fluid will be collected in the depression 148, from which it may be easily cleaned. In addition, if the operator wishes to change a fuse in the fuse box, for example, should he or she drop a fuse, the fuse will be collected by the depression so that it may be easily found.

Also as may be appreciated from FIG. 8, the bottom 150 of the depression 148 is offset a predetermined distance from the surrounding surface of the front fairing assembly 102. In other words, the bottom 150 of the depression 148 does not form a part of the exterior appearance of the ATV 80 as does the remainder of the front fairing assembly 102. Moreover, in the illustrated embodiment, side walls 151 connect between the surface of the front fairing assembly 102 to the bottom 150 of the depression 148. While the embodiment illustrates that the walls 151 extend around the periphery of the depression 148, this is not required to practice the present invention. To the contrary, finger-like elements could extend from the surface of the front fairing assembly 102 to the bottom 150 of the depression 148.

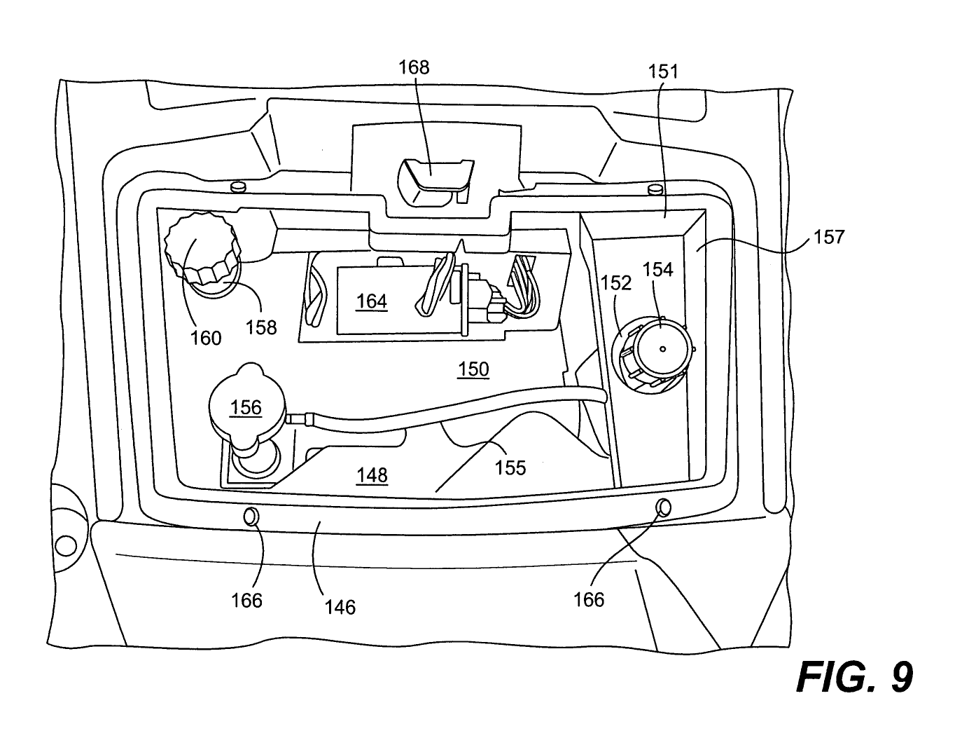

FIG. 9 illustrates the service center 146 with the electrical component cover 162 removed, exposing a electrical components 164 covered by the cover 162. As shown, the electrical components preferably are positioned so that they are accessible through the holes in the bottom 150 of the depression 148.

As shown in FIG. 10, the electrical component cover 162 preferably is made from a plastic material so that the cover 162 is resilient and durable. The cover 162 preferably acts as a barrier to prevent accidental tampering with the electrical components located therebeneath.

The electrical component cover 162 preferably removably attaches to the bottom 150 of the depression 148. In particular, it is desired that the electrical component cover 162 engage the front fairing assembly 102 at the bottom 150 of the depression 148. To do this, it is contemplated that the front fairing assembly 102 may be provided with slots into which tabs on the cover 162 may protrude to hold the cover 162 in place. Of course, as would be appreciated by those skilled in the art, any other alternative connecting arrangement may be used without deviating from the scope of the present invention.

In an alternative embodiment, which is not illustrated, the electrical components 164 to which access is desired through the service center 146 may be assembled onto a base portion to which the cover 162 attaches. In this manner, a sealed compartment may be established around the electrical components 164 so that they are prevented from being splashed with water or other fluids during operation of the ATV 80.

As illustrated in FIG. 8, the depression 148 may be integrally formed as a part of the front fairing assembly 102. Alternatively, as illustrated in FIG. 9, the depression 148 may be formed as a separate component that is subsequently attached to the front fairing assembly 102 via one or more fasteners 166. In still another alternative embodiment, the depression 148 may be manufactured separately and attached to the front fairing assembly 102 via an adhesive. Other constructions are also contemplated to fall within the scope of the present invention. For example, while not illustrated, the depression 148 may be assembled from several separate components before being incorporated into the front fairing assembly 102.

FIG. 10 provides a close-up view of the service center 146 illustrated in FIG. 8. In this embodiment, the electrical component cover 162 is shown attached to the front fairing assembly 102. In particular, the electrical component cover 162 is attached to the bottom 150 of the depression 148 in the front fairing assembly 102.

As illustrated in FIG. 10, the latch mechanism 168 is shown in greater detail. The latch mechanism 168 is positioned at the rear portion of the depression 148. The latch mechanism 148 is an L-shaped, flexible member designed to engage a lip on the central front rack portion 136 so that the central front rack portion 136 is securely fastened on the front fairing assembly 102 over the depression 148. The latch mechanism 168 is designed to work in concert with the holes 170 in the front fairing assembly 102 at the front of the depression 148.

The central front rack portion 136 is a cover for the front service center 146. The central front rack portion 136 also functions as the central rear rack portion 144. In particular, the two covers 136, 144 are designed to be the same size and configuration so that they are interchangeable. This reduces consumer confusion when both covers are removed. It also permits the manufacturer to make a single cover that can be used both at the front and rear of the ATV 80. As would be appreciated by those skilled in the art, the two covers 136, 144 alternatively could be manufactured so that they are sized and shaped differently from one another without deviating from the scope of the present invention.

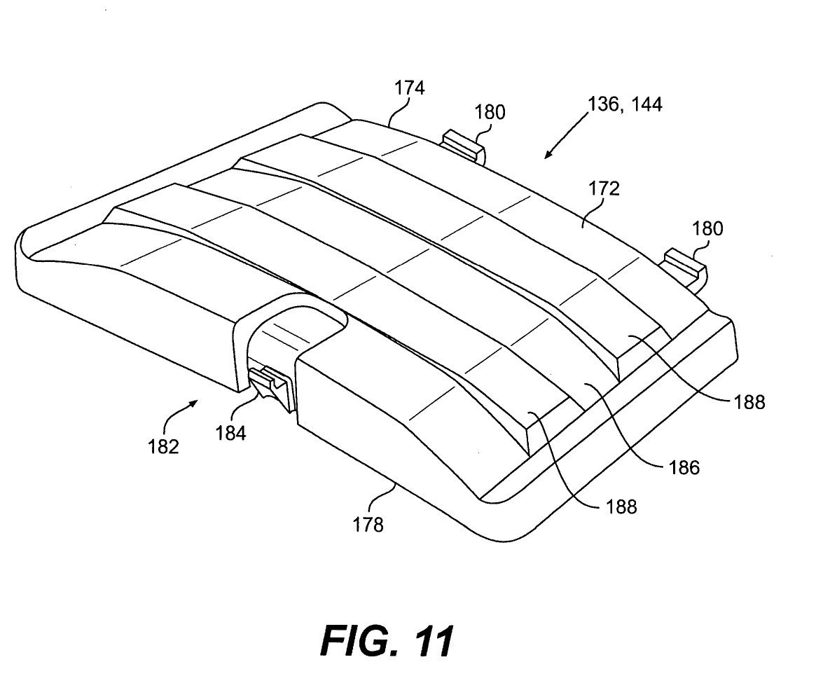

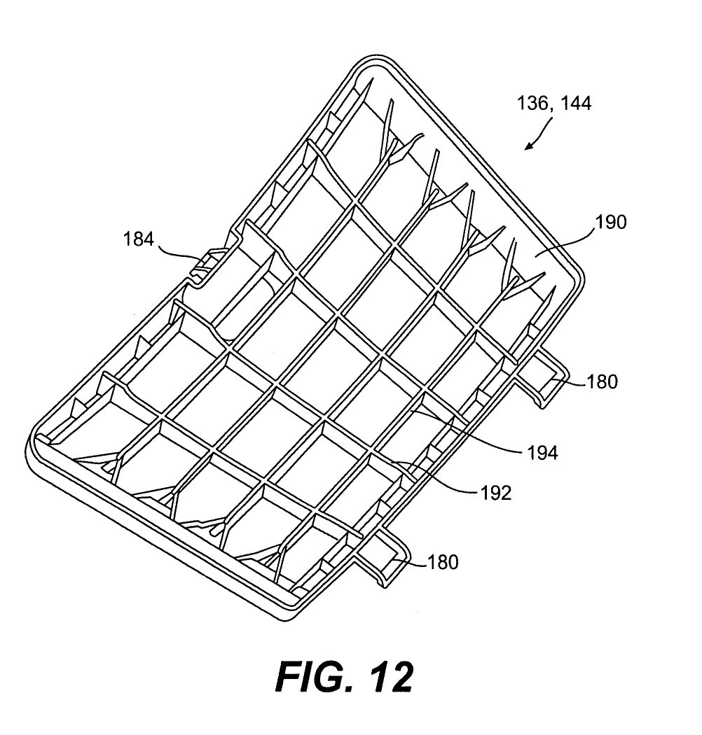

The central rack portion 136, 144 is illustrated in detail in FIGS. 11 and 12. As shown in FIG. 11, the central rack portion 136, 144 has a body 172 that is roughly trapezoidally shaped. The narrow side 174 of the body 172 is intended to be disposed closer to the central portion 176 of the ATV 80 than the wide side 178. The narrow side 174 includes two tabs 180 that protrude outwardly therefrom. The wide side 178 includes a notch 182 that includes a lip 184. The lip 184 is designed to mate with the latch mechanism 168 described above.

The body of the central rack portion 136, 144 includes a top surface 186 that has been contoured to include at least two laterally-extending ridges 188 thereon. The ridges 188 function as part of the front and rear storage racks 130, 138. As indicated in FIGS. 7, 10, 13, and 14, the tabs 180 are designed to engage the holes 170 in the front and rear fairing assemblies 102, 118. The latch mechanisms 168 engage the lips 184 on the covers 136, 144 so that the covers 136, 144 are held securely in place on the front and rear fairing assemblies 102, 118.

As shown in FIG. 12, the bottom surface 190 of the cover 136, 144 is provided with a plurality of longitudinally-extending ribs 192 and laterally-extending ribs 194. The ribs 192, 194 provide structural rigidity to the cover 136, 144.

Preferably, the cover 136, 144 is manufactured as a unitary component made from a plastic material. The tabs 180, notch 182, and lip 184 are all preferably molded as a part of the cover 136, 144. As would be appreciated by those skilled in the art, however, the cover 136, 144 may be made from any suitable material including steel or aluminum. Moreover, the tabs 180 and lip 184 may be manufactured as separate components that are later assembled onto the cover without deviating from the scope of the present invention.

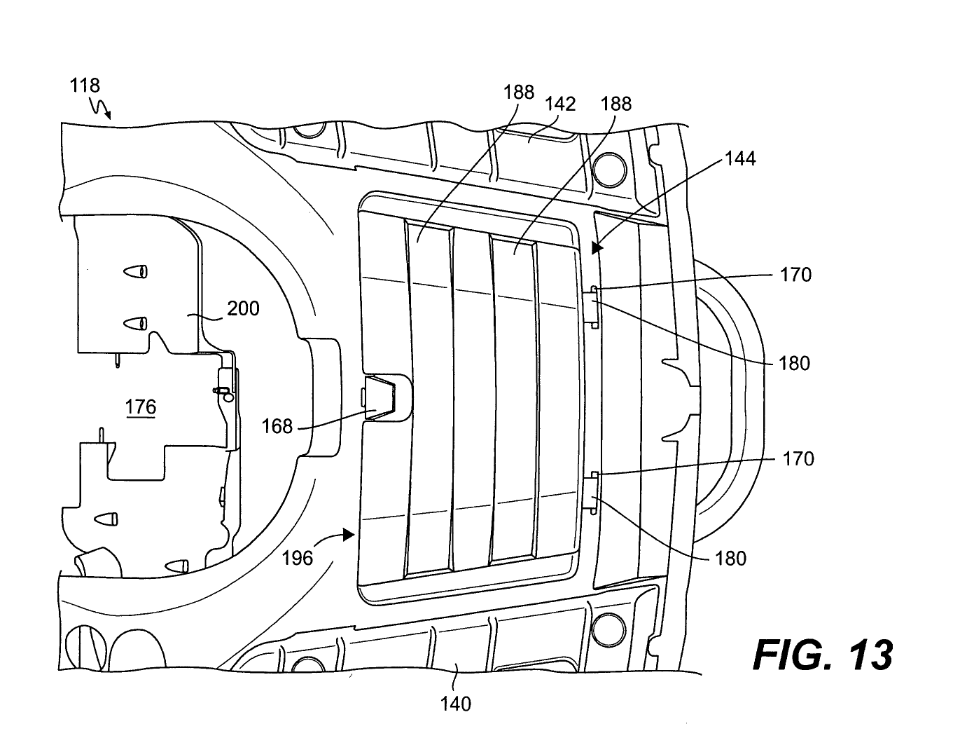

FIG. 13 provides a top view of the rear trunk 196 for the ATV 80. The rear trunk 196 is shown with the rear central rack portion (or cover) 144 thereover. As illustrated, the forward end of the cover 144 is retained by the latch mechanism 168. The tabs 180 on the rear cover 144 engage holes 170 in the rear fairing assembly 118 to securely retain the rear cover 144 on the rear fairing assembly 118.

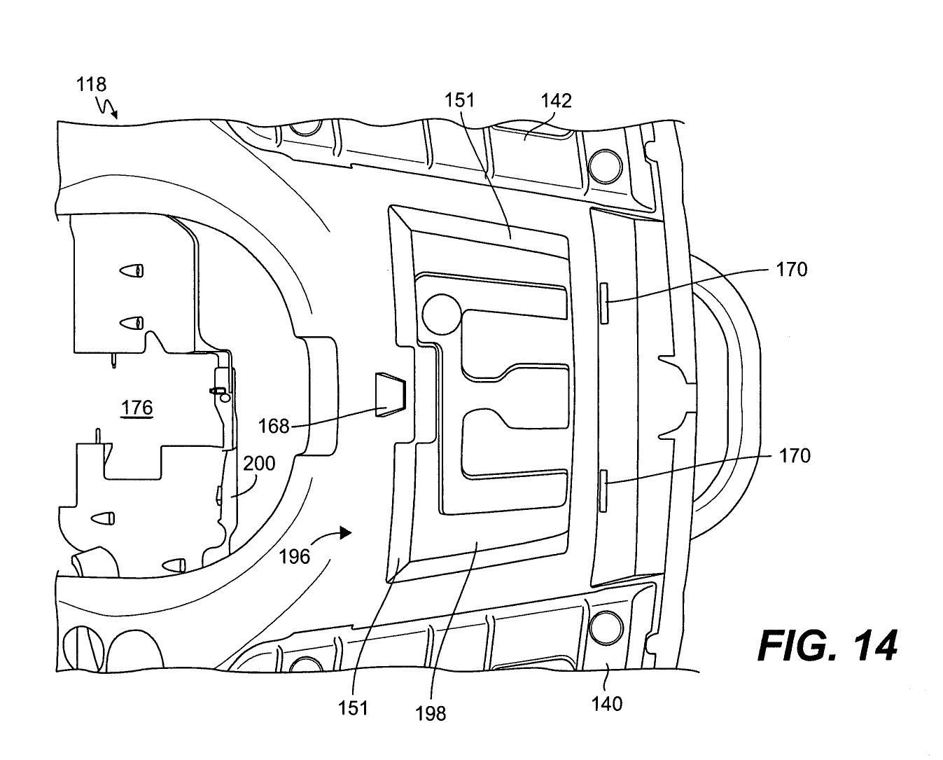

FIG. 14 provides a top view of the rear fairing assembly 118 with the rear central rack portion 144 removed to reveal the interior of the trunk 196. The trunk 196 is formed by a depression 198 in the rear fairing assembly 118, just like the service center 146 is formed by the depression 148 in the front fairing assembly 102. In the illustrated embodiment, the trunk 196 does not include any cut-outs or holes to facilitate access to any mechanical components of the ATV 80. However, it is contemplated that the trunk 196 could be designed to provide access to certain components at the rear of the ATV 80 just as with the front service center 146. In particular, if the radiator 94 were positioned at the rear of the ATV 80, access to the radiator cap 156 may be provided in the trunk 196.

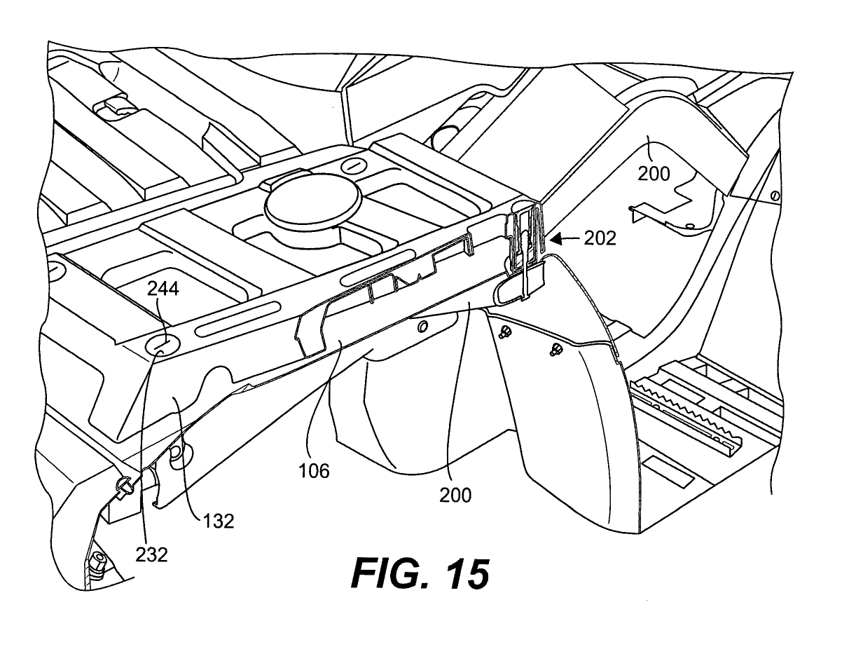

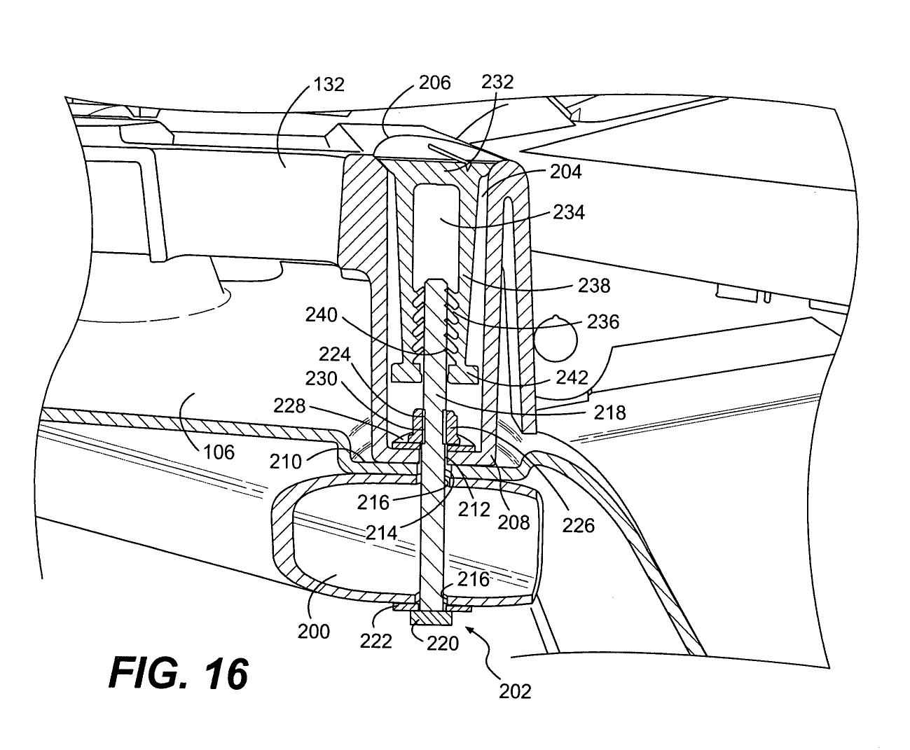

FIG. 15 is a partial cross-sectional view of the left front storage rack portion 132 positioned above the left front fender 106. As illustrated, the left front rack portion 132 is attached to the front left fender 106 and the frame 200 of the ATV 80 via a fastener 202. FIG. 16 illustrates the fastener 202 in greater detail.

As shown in FIG. 16, the fastener 202 is made up of several separate components that cooperate to securely fasten the left front rack portion 132 to the left front fender 106 and frame 200 of the ATV 80. As the remaining figures indicate, the remaining portions 134, 142, 146 of the front and rear storage racks 130, 138 are attached to the frame 200 via a plurality of the fasteners 202. As a result, the discussion that follows is equally applicable to the remaining rack portions 134, 140, 142 as well.

The left front rack portion 132 includes several hollow bores 204 therein. The hollow bores 204 extend from a top surface 206 of the left front rack portion 132 to a bottom portion 208. The bottom portion 208 registers with an indentation 210 in the left front fender 106. The bottom portion 208 has a hole 212 therethrough that registers with a hole 214 in the left front fender 106 and a hole 216 in the frame 200.

To attach the left front rack portion 132 to the frame 200, a pin 218 is inserted through the hole 216 in the frame 200 so that the head 220 of the pin sandwiches a washer 222 between itself and the frame 200. The shaft of the pin 218 extends through the frame 200, passes through the holes 212, 214, and is positioned within the hollow bore 204. The shaft of the pin 218 includes a number of grooves 224 therein. A grommet 226 sandwiches a washer 228 between itself and the bottom portion 208 of the hollow bore 204. The grommet 226 includes a plurality of protrusions 230 on the inner surface of the bore therethrough. The protrusions 230 engage the grooves 224 on the shaft of the pin 218 to retain the grommet 226 in a fixed relationship to the pin 218. In this manner the left front rack portion 132 is held securely to the frame 200.

To cover the hollow bore 204, a cap 232 is provided. The cap 232 has a hollow interior 234. At a bottom portion of the hollow interior 234, the cap 232 is provided with a number of protrusions 236 that extend inwardly from a wall 238. The protrusions 236 are designed to mate with grooves 240 on the tip end of the pin 218 so that the cap 232 is secured to the pin 218, thereby closing the hollow bore 204. To provide greater rigidity to the wall 238, an annular end 242 is provided at the bottom end of the cap 232.

The protrusions 230 on the grommet 226 are illustrated as vertical protrusions that engage vertically-disposed grooves 224 on the pin 218. As would be appreciated by those skilled in the art, however, the protrusions 230 and grooves 224 may be designed to threadedly engage one another, thereby securely fastening the left front rack portion 132 to the frame 200.

Similarly, the protrusions 236 on the wall 238 of the cap 232 may be designed to threadedly engage the grooves 240 on the pin 218. As illustrated in FIG. 15, the cap 232 may be provided with a slot 244 into which a screwdriver may be inserted to tighten the cap 232 in the hollow bore 204.

The individual elements of the fastener 202 preferably are constructed from a plastic material to provide the greatest amount of flexibility while retaining a sufficient amount of rigidity to create a secure connection between the left front rack portion 132, the left front fender 106, and the frame 200. However, as would be appreciated by those skilled in the art, any other suitable material may be used, including steel, aluminum, or an equivalent material.

The construction of the ATV 80 of the present invention specifically contemplates that one or more of the components attached to the engine will be accessible at the service center 146 of at the trunk 196. The components contemplated for access include, but are not limited to: at least a portion of a brake fluid system, a brake fluid reservoir, a brake fluid fill spout, at least a portion of a coolant system, a coolant reservoir, a coolant reservoir fill spout, at least a part of a radiator, a radiator overflow, a radiator fill spout, an electronic control unit, at least part of an engine oil system, an engine oil fill spout, a battery, and a fuse box, among others. Other components also may be accessible such as a first aid kit, a tool kit, an emergency kit including flares, for example, a fire extinguisher, a coast guard safety kit including at least a whistle, etc. The concentration, or clustering, of one or more of these components in a single area on the ATV 80 greatly facilitates maintenance on the vehicle and greatly enhances accessibility to needed items.

As indicated above, the service center 146 of the present invention is not limited solely to incorporation into an ATV 80. To the contrary, the service center 146 of the present invention may be incorporated into any other suitable vehicle including a snowmobile, personal watercraft, boat, or a three-wheeled vehicle.

While the service center 146 may be incorporated into a wide variety of vehicles, it is contemplated that the service center will be the most useful when incorporated into recreational vehicles such as ATVs, three-wheeled vehicles, snowmobiles, boats, and personal watercraft (PWCs). Each of these vehicles include a seat disposed on a frame or on a deck. In the case of an ATV, a snowmobile, a three-wheeled vehicle, and a PWC, the seat is a straddle-type seat, which means that the rider straddles the seat with one leg on either side thereof.

For purposes of this discussion, the deck of a PWC is considered to be synonymous with the term “frame” and the term “fairing” is intended to encompass a portion of the deck or a surface associated with the deck. For example, the “fairing” on a PWC could be a surface including a depression 148 that is disposed above or adjacent to the engine. In the case of ATVs, three-wheeled vehicles, and snowmobiles, the vehicles include either tires or skis, referred to herein as steerable members, that are turned via a handlebar. A PWC also is controlled by a handlebar. The steerable member on a PWC is the nozzle (and possibly one or more rudders) at the rear of the watercraft, the position of which is (are) controlled by the handlebar. It is noted that a boat typically includes rudders that operate in combination with a propeller. In such a case, the steerable member on a boat is meant to encompass at least the rudder (or rudders).

In addition, it is noted that each of these recreational vehicles are typically powered by an internal combustion engine, supported by either the frame or deck. While an internal combustion engine is most commonly used, the recreational vehicles could be powered by an electrical motor driven by a fuel cell, battery, or other similar device. For purposes of this discussion, the term “engine” is intended to encompass any type of device capable of generating power that may be translated into propulsive force for the recreational vehicle.

It should be understood that the embodiments described above are not meant to limit the scope of the present invention. To the contrary, the embodiments are meant to illustrate one or more ways in which the invention may be practiced. It is contemplated that the present invention may be practiced in a number of different ways without departing from the scope of the present invention.

What is claimed is:

1. A vehicle, comprising:
a frame;
a seat supported by the frame;
a steerable member supported by the frame providing directional control for the frame;
a steering device disposed on the frame, constructed to control the steerable member;
an engine disposed on the frame, providing propulsive force for the frame;
at least one component operatively connected to at least one of the engine or the steerable member, the at least one component being selected from a group comprising at least a portion of a brake fluid system, a brake fluid reservoir, a brake fluid fill spout, at least a portion of a coolant system, a coolant reservoir, a coolant reservoir fill spout, at least a part of a radiator, a radiator overflow, a radiator fill spout, an electronic control unit, at least part of an engine oil system, an engine oil fill spout, a battery, and a fuse box; and
a fairing incorporated into the frame,
wherein the fairing has a first surface forming at least a portion of an outer surface of the vehicle,
wherein the fairing has a second surface, at least a portion of which is offset a predetermined distance from the first surface, the second surface being disposed adjacent to the at least one component, and
wherein the second surface defines at least one hole therethrough permitting access to the at least one component.

2. The vehicle of claim 1, wherein the fairing also has a third surface, connecting the first and second surfaces to one another.

3. The vehicle of claim 2, wherein the second and third surfaces are integrally molded with the first surface so that the second and third surfaces form a depression in the fairing with respect to the first surface.

4. The vehicle of claim 1, wherein the first and second surfaces are integrally molded to form the fairing.

5. The vehicle of claim 1, wherein the second surface is attached to the first surface to form the fairing.

6. The vehicle of claim 1, further comprising:
a cover constructed to be positioned above at least a portion of the second surface.

7. The vehicle of claim 6, further comprising:
a latch mechanism, engageable with at least a portion of the cover, the latch mechanism releasably securing the cover to the fairing.

8. The vehicle of claim 6, wherein the cover comprises:
a body defining a peripheral edge; and
at least one tab extending from the peripheral edge of the body.

9. The vehicle of claim 8, wherein the fairing defines at least one hole therethrough for engagement of the at least one tab.

10. The vehicle of claim 1, wherein the first and second surfaces define a service center for the vehicle.

11. The vehicle of claim 10, wherein the service center is disposed at one of either a front end and a rear end of the vehicle.

12. The vehicle of claim 1, wherein:
the seat is a straddle-type seat,
the frame is for a land-going vehicle, and
the fairing is attached to the frame.

13. The vehicle of claim 12, wherein:
the land-going vehicle is one of an all terrain vehicle and a three-wheeled vehicle, and
the steerable member comprises at least one wheel.

14. The vehicle of claim 12, wherein:
the land-going vehicle is a snowmobile, and
the steerable member comprises at least one ski.

15. The vehicle of claim 1, wherein:
the frame is a deck for a water-going vehicle,
the fairing is integrally molded as a part of the deck, and
the water-going vehicle is one of a personal watercraft and a boat.

16. The vehicle of claim 15, wherein the steerable member is a directional nozzle.

17. The vehicle of claim 15, wherein the steerable member is a rudder.

18. The vehicle of claim 1, wherein the at least one component includes at least two of:
at least a portion of a brake fluid system, a brake fluid reservoir, a brake fluid fill spout, at least a portion of a coolant system, a coolant reservoir, a coolant reservoir fill spout, at least a part of a radiator, a radiator overflow, a radiator fill spout, an electronic control unit, at least part of an engine oil system, an engine oil fill spout, a battery, and a fuse box.

19. The vehicle of claim 18, wherein the at least two components are clustered adjacently to the second surface.
